(19) United States
(12) Patent Application Publication
(10) Pub. No.: US 2026/0189068 A1
(43) Pub. Date: Jul. 2, 2026

(54) WIRELESS CHARGING RECEIVER AND ELECTRONIC PRODUCT

(71) Applicant: Lanto Electronic Limited, Kunshan City (CN)

(72) Inventors: Bang LIANG, Kunshan City (CN); Liefeng JIN, Kunshan City (CN)

(73) Assignee: Lanto Electronic Limited, Kunshan City (CN)

(21) Appl. No.: 19/316,954

(22) Filed: Sep. 2, 2025

(30) Foreign Application Priority Data
Dec. 31, 2024 (CN) 202412000386.2

(51) Int. Cl. H02J 50/00; H01F 5/04; H01F 27/02; H02J 50/10

(52) U.S. Cl. CPC H02J 50/005; H01F 5/04; H01F 27/025; H02J 50/10; H01F 2005/046

(57) ABSTRACT

Provided are a wireless charging receiver and an electric product. The wireless charging receiver includes a first soft magnet, a receiving coil, and a flexible circuit board. The first soft magnet is provided with a first through hole. The receiving coil is arranged below the first soft magnet and includes a first connection end coiled on the inner side of the receiving coil and a second connection end coiled on the outer side of the receiving coil. The flexible circuit board includes an inner conductor wire and an outer conductor wire. The inner conductor wire is located above the first soft magnet and connected to the first connection end after passing through the first through hole, and the outer conductor wire is located below the first soft magnet and connected to the second connection end. The electric product includes a battery and the preceding wireless charging receiver.

### CROSS-REFERENCE TO RELATED APPLICATION(S)

This application claims priority to Chinese Patent Application No. 202412000386.2 filed Dec. 31, 2024, the disclosure of which is incorporated herein by reference in its entirety.

### TECHNICAL FIELD

The present application relates to the field of wireless charging technology and, in particular, to a wireless charging receiver and an electronic product.

### BACKGROUND

A wireless charging receiver mainly includes a receiving coil, a soft magnet, and a circuit board. The wireless charging receiver is built into an electronic product needing to be charged, such as a mobile phone, a tablet, or a smartwatch. When the electronic product needing to be charged approaches a charging base, a transmitting coil within the charging base generates a certain current in a receiving coil of the electronic product through electromagnetic induction based on an alternating current of a certain frequency, thereby sending energy from a transmitting end to a receiving end so that the charging base can charge the electronic product.

### SUMMARY

Based on the preceding, an object of the present application is to provide a wireless charging receiver and an electronic product.

The present application adopts the technical solutions below.

A wireless charging receiver is provided. The wireless charging receiver includes a first soft magnet, a receiving coil, and a flexible circuit board.

The first soft magnet is provided with a first through hole passing through an upper surface of the first soft magnet and a lower surface of the first soft magnet.

The receiving coil is arranged below the first soft magnet, where the receiving coil includes a first connection end coiled on an inner side of the receiving coil and a second connection end coiled on an outer side of the receiving coil.

The flexible circuit board includes an inner conductor wire and an outer conductor wire, where the inner conductor wire is located above the first soft magnet and connected to the first connection end after passing through the first through hole, and the outer conductor wire is located below the first soft magnet and connected to the second connection end.

An electronic product is provided. The electronic product includes a battery and the above wireless charging receiver, where the wireless charging receiver is configured to charge the battery.

### BRIEF DESCRIPTION OF DRAWINGS

FIG. 1 is a diagram illustrating the front structure of a wireless charging receiver according to one or more embodiments of the present application.

FIG. 2 is a diagram illustrating the front structure of a wireless charging receiver (a second soft magnet is not shown) according to one or more embodiments of the present application.

FIG. 3 is a diagram illustrating the back structure of a wireless charging receiver (a connector is not shown) according to one or more embodiments of the present application.

FIG. 4 is an exploded diagram of a wireless charging receiver according to one or more embodiments of the present application.

FIG. 5 is a diagram illustrating the structure of a receiving coil and a flexible circuit board according to one or more embodiments of the present application.

FIG. 6 is a diagram illustrating the structure of an inner conductor wire of a flexible circuit board according to one or more embodiments of the present application.

FIG. 7 is a diagram illustrating the temperature rise simulation of a wireless charging receiver during charging according to one or more embodiments of the present application.

FIG. 8 is a diagram illustrating the structure of a reinforcement component according to one or more embodiments of the present application.

### REFERENCE LIST

1 first soft magnet
11 first through hole
12 second through hole
2 receiving coil
21 first connection end
22 second connection end
3 flexible circuit board
31 inner conductor wire
311 sub-wire
32 outer conductor wire
4 second soft magnet
5 connector
6 reinforcement component

### DETAILED DESCRIPTION

The present application is described below in detail in conjunction with the drawings and embodiments. It is to be understood that the embodiments described herein are intended to explain the present application and not to limit the present application. Additionally, it is to be noted that for ease of description, only part, not all, of the structures related to the present application are illustrated in the drawings.

In the description of the present application, terms “joined”, “connected”, and “secured” are to be understood in a broad sense unless otherwise expressly specified and limited. For example, the term “connected” may refer to “securely connected”, “detachably connected”, or “integrated”, may refer to “mechanically connected” or “electrically connected”, may refer to “connected directly” or “connected indirectly through an intermediary”, or may refer to “connected inside two elements” or “an interaction relation between two elements”. For those of ordinary skill in the art, specific meanings of the preceding terms in the present application may be understood based on specific situations.

In the present application, unless otherwise expressly specified and limited, when a first feature is described as “above” or “below” a second feature, the first feature and the second feature may be in direct contact, or be in contact via another feature between the two features. Moreover, when the first feature is described as “on”, “above”, or “over” the second feature, the first feature is right on, above, or over the second feature, the first feature is obliquely on, above, or over the second feature, or the first feature is simply at a higher level than the second feature. When the first feature is described as “under”, “below”, or “underneath” the second feature, the first feature is right under, below, or underneath the second feature, the first feature is obliquely under, below, or underneath the second feature, or the first feature is simply at a lower level than the second feature.

In the description of the present application, it is to be noted that orientations or positional relations indicated by terms such as “above”, “below”, “left”, and “right” are based on the drawings. These orientations or positional relations are intended only to facilitate the description and simplify an operation and not to indicate or imply that a device or element referred to must have such specific orientations or must be configured or operated in such specific orientations. Thus, these orientations or positional relations are not to be construed as limiting the present application. Additionally, terms “first” and “second” are used for distinguishing between descriptions and have no special meanings.

A wireless charging receiver in the related art includes a soft magnet, a receiving coil, and a flexible circuit board. The receiving coil and wires of the flexible circuit board are located on the same side of the soft magnet. This structure is prone to generate a vortex in the flexible circuit board, thereby causing the wireless charging receiver to generate a large amount of heat and resulting in an excessive temperature rise of an electronic product. If the magnitude of a charging current is limited, though the heating is reduced, the low charging efficiency of the electronic product is easily caused.

In view of the preceding problems, one or more embodiments of the present application provide a wireless charging receiver that serves as a receiving end of a wireless charging system and may be applied to the electronic product such as a mobile phone, a tablet, a laptop, a smartwatch, or smart glasses to solve the problems in the related art of the excessive temperature rise of the electronic product during wireless charging and a too slow charging speed of the electronic product after the charging current is limited.

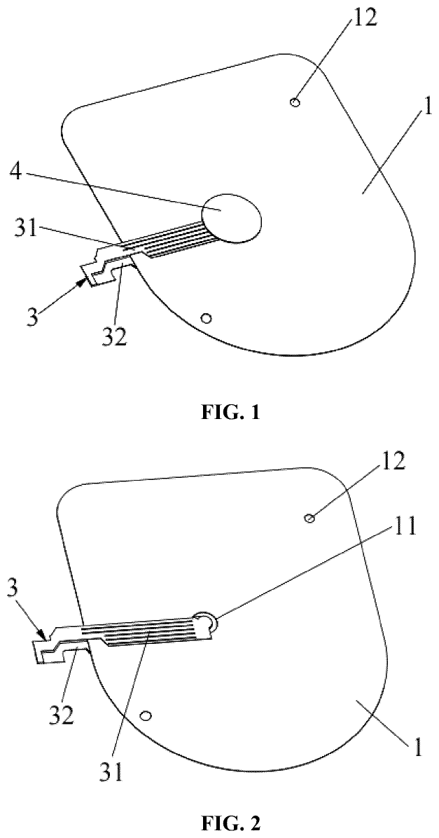

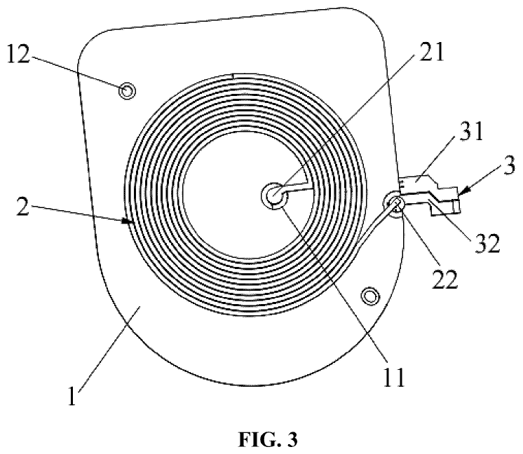

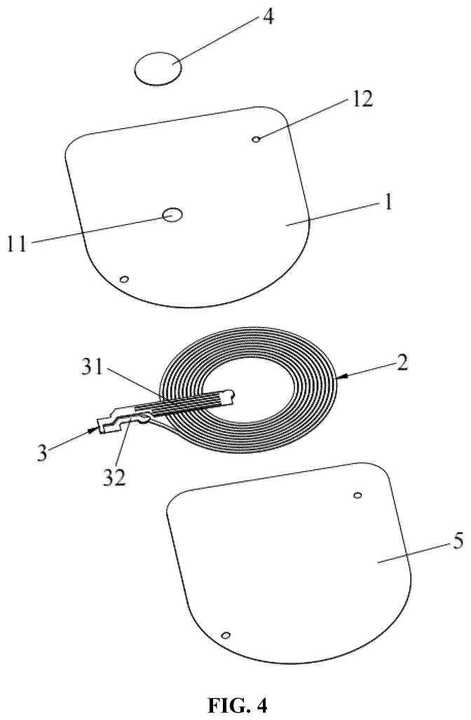

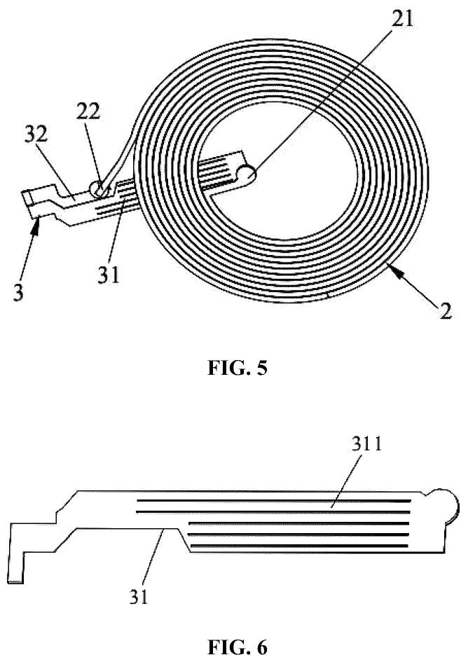

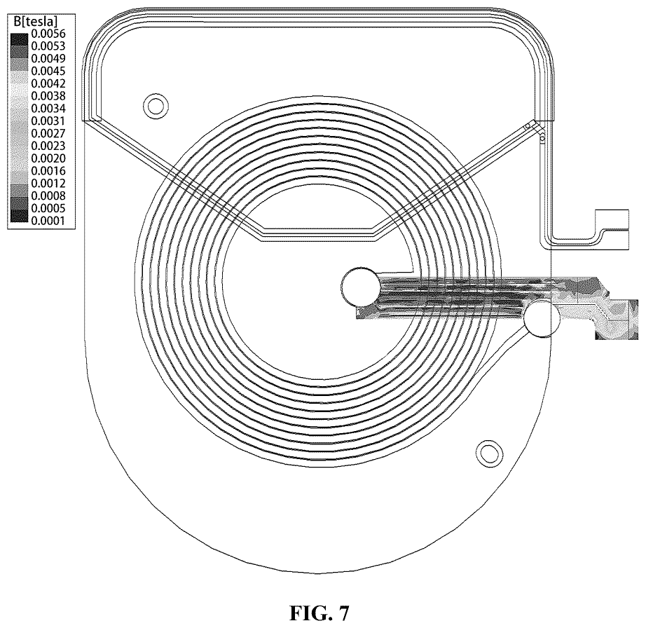

As shown in FIGS. 1 to 8, the wireless charging receiver provided in the embodiments includes a first soft magnet 1, a receiving coil 2, and a flexible circuit board 3 so that the temperature rise of the electronic product during wireless charging is lowered, and the charging efficiency of the electronic product is improved. The first soft magnet 1 has the function of electromagnetic shielding. The first soft magnet 1 is provided with a first through hole 11 passing through the upper surface of the first soft magnet 1 and the lower surface of the first soft magnet 1. In one or more embodiments, the first through hole 11 is arranged in a middle region of the first soft magnet 1. The receiving coil 2 is arranged below the first soft magnet 1. The receiving coil 2 is specifically a winding coil containing a metal material, which is coiled in a ring shape. The receiving coil 2 includes a first connection end 21 coiled on the inner side of the receiving coil 2 and a second connection end 22 coiled on the outer side of the receiving coil 2. The first connection end 21 is arranged below the first through hole 11, and the second connection end 22 is adjacent to an edge portion of the first soft magnet 1. The flexible circuit board 3 includes an inner conductor wire 31 and an outer conductor wire 32. The inner conductor wire 31 is located above the first soft magnet 1 and connected to the first connection end 21 after passing through the first through hole 11. The outer conductor wire 32 is located below the first soft magnet 1 and connected to the second connection end 22. In this manner, a closed circuit is formed to charge the electronic product. In the embodiments, the flexible circuit board 3 is a single-sided FPC wire board or a double-sided FPC wire board.

In the wireless charging receiver provided in the embodiments, the inner conductor wire 31 of the flexible circuit board 3 and the outer conductor wire 32 of the flexible circuit board 3 are arranged on the upper side of the first soft magnet 1 and the lower side of the first soft magnet 1 respectively. The inner conductor wire 31 is located above the first soft magnet 1, and the outer conductor wire 32 is located below the first soft magnet 1. After passing through the first through hole 11, the inner conductor wire 31 is connected to the first connection end 21 that is located below the first soft magnet 1 and coiled on the inner side of the receiving coil 2. The outer conductor wire 32 is connected to the second connection end 22 coiled on the outer side of the receiving coil 2. Since a vortex is prone to be generated in the inner conductor wire 31 in the flexible circuit board 3, the embodiments use the first soft magnet 1 to separate the inner conductor wire 31 from the receiving coil 2, thereby reducing the vortex formed by a magnetic field of the receiving coil 2 on the inner conductor wire 31, effectively reducing heat generated by the wireless charging receiver, lowering the temperature rise of the electronic product, and improving the user experience and the charging safety of the electronic product. Moreover, in the embodiments, the wireless charging receiver is continuously stabilized in a high-current and full-load operation state, thereby effectively improving the efficiency of wireless charging and accelerating the charging speed of the electronic product.

In one or more embodiments, a portion of the outer conductor wire 32 is arranged right below the first soft magnet 1 and is configured to be connected to the second connection end 22 of the receiving coil 2 so as to prevent the second connection end 22 from extending out of the first soft magnet 1; another portion of the outer conductor wire 32 is laterally exposed from the first soft magnet 1 to be connected to the inner conductor wire 31. In one or more embodiments, a portion of the outer conductor wire 32 located right below the first soft magnet 1 is fitted with the lower surface of the first soft magnet 1 so as to ensure the stability of the connection between the outer conductor wire 32 and the first soft magnet 1.

Further, a portion of the inner conductor wire 31 is arranged right above the first soft magnet 1 and is configured to be connected to the first connection end 21 of the receiving coil 2; another portion of the inner conductor wire 31 is laterally exposed from the first soft magnet 1; an end portion of the inner conductor wire 31 laterally exposed from the first soft magnet 1 is connected to an end portion of the outer conductor wire 32 laterally exposed from the first soft magnet 1. In one or more embodiments, a portion of the inner conductor wire 31 located right above the first soft magnet 1 is fitted with the upper surface of the first soft magnet 1 so as to ensure the connection stability between the inner conductor wire 31 and the first soft magnet 1.

In one or more embodiments, the wireless charging receiver of the embodiments further includes a second soft magnet 4 that is arranged above the first soft magnet 1 and covers above a connection position between the inner conductor wire 31 and the first connection end 21. In this embodiment, the second soft magnet 4 is arranged above the inner conductor wire 31 so that the magnetic flux leakage of the receiving coil 2 at the first through hole 11 is shielded, further improving the electromagnetic shielding effect and improving the performance of the wireless charging receiver.

In this embodiment, the coverage area of the first soft magnet 1 is larger than the coverage area of the receiving coil 2 so that the receiving coil 2 is completely mounted on the first soft magnet 1, and the receiving coil 2 is effectively electromagnetically shielded through the first soft magnet 1. Further, the coverage area of the second soft magnet 4 is smaller than the coverage area of the receiving coil 2 and larger than the area of the first through hole 11. In this embodiment, the dimension of the second soft magnet 4 is just required to cover the connection position between the inner conductor wire 31 and the first connection end 21 and is not necessarily arranged too large, so as to avoid material waste. In one or more embodiments, in this embodiment, the shape of the receiving coil 2 is toroidal, the first soft magnet 1 is a rectangular-like (that is, an end of the rectangle is a circular arc) soft magnetic sheet, and the second soft magnet 4 is a circular soft magnetic sheet. In other embodiments, the shape of the receiving coil 2, the shape of the first soft magnet 1, and the shape of the second soft magnet 4 may also be arranged as other shapes and are not limited to this embodiment.

In this embodiment, the material of the first soft magnet 1 and the material of the second soft magnet 4 may be ferrite materials, ferrite amorphous materials, ferrite amorphous nanomaterials, or ferrite composite materials. In one or more embodiments, in this embodiment, the first soft magnet 1 and the second soft magnet 4 are both made of nanocrystalline materials or ferrites. Nanocrystalline has high saturation magnetic induction intensity, high magnetic permeability, and low magnetic loss, and can be soft and ultra-thin. A ferrite is prepared and sintered by ferric oxide and one or more other metal oxides (such as nickel oxide, zinc oxide, manganese oxide, magnesium oxide, barium oxide, and strontium oxide), can be mass-produced, and has stable performance and high mechanical processing performance.

In one or more embodiments, in this embodiment, the inner conductor wire 31 of the flexible circuit board 3 includes multiple sub-wires 311 arranged in parallel. Since a region with the strongest magnetic field (that is, the region that is most likely to form a vortex) in the flexible circuit board 3 is the inner conductor wire 31, the inner conductor wire 31 is subdivided into the multiple sub-wires 311 in the embodiments so that the vortex in a circuit is further reduced. Specifically, the inner conductor wire 31 in the embodiments may be a litz wire or a self-adhesive enameled wire. It is to be noted that the preceding litz wire refers to a wire in which a conductor is twisted or braided by multiple independently insulated conductors; the preceding self-adhesive enameled wire refers to a wire in which each turn of coils is bonded to each other under an appropriate solvent or a heating condition. Exemplarily, the inner conductor wire 31 in the embodiments is a flat wire with a certain width, and the flat wire is divided into the multiple parallel and spaced sub-wires 311 in a region right above the first soft magnet 1, which has a simple structure, is easy to process, and has stable performance.

In one or more embodiments, the wireless charging receiver in the embodiments further includes a connector 5 that is arranged on a side of the receiving coil 2 facing away from the first soft magnet 1 and is configured to be secured to the electronic product. In this embodiment, the connector 5 is arranged on the side of the receiving coil 2 so that the wireless charging receiver is better assembled with a mobile phone, a tablet, or other complete machine. Specifically, the connector 5 is a colloid or Mylar. Further, the connector 5 is sheet-shaped, which is the same as the shape of the first soft magnet 1 to achieve a better connection effect. In this embodiment, when the connector 5 is a colloid, the colloid may be a hot melt adhesive or a pressure-sensitive adhesive and may be a double-sided adhesive or a single-sided adhesive; when the connector 5 is Mylar, the first soft magnet 1 is provided with a second through hole 12 passing through the upper surface of the first soft magnet 1 and the lower surface of the first soft magnet 1, and the Mylar is also provided with a connection hole so that the wireless charging receiver and the electronic product can be fastened by fastening screws.

In this embodiment, the first connection end 21 of the receiving coil 2 is connected to the inner conductor wire 31 of the flexible circuit board 3 by welding, and the second connection end 22 of the receiving coil 2 is connected to the outer conductor wire 32 of the flexible circuit board 3 by welding. After forming a circuit, the receiving coil 2 and the flexible circuit board 3 are connected to the electronic product such as a mobile phone or a tablet to charge the electronic product. In one or more embodiments, the receiving coil 2 is adhesively secured to the first soft magnet 1, the first soft magnet 1 is adhesively secured to the flexible circuit board 3, and the second soft magnet 4 is adhesively secured to the first soft magnet 1. For example, the adhesions may be performed by a single-sided adhesive or a double-sided adhesive. The preceding connection manner is easy to operate and flexible to assemble.

In one or more embodiments, the wireless charging receiver in the embodiments further includes a heat dissipation component that is configured to dissipate the heat of the receiving coil 2 to further lower the temperature rise of the electronic product. Specifically, the heat dissipation component may be a graphite heat sink or a silicone heat sink, and the heat dissipation component is adhesively secured to the first soft magnet 1 or the connector 5 to improve the heat dissipation capability of the electronic product.

In one or more embodiments, the wireless charging receiver in the embodiments further includes a rigid protective film component that is arranged on the outer side of the first soft magnet 1 to increase the rigidity of the wireless charging receiver and improve the structural strength. Further, as shown in FIG. 8, the wireless charging receiver further includes a reinforcement component 6 secured to the first soft magnet 1 or the receiving coil 2. The reinforcement component 6 may be specifically a reinforcement plate, and the material of the reinforcement plate may be optionally plastic or metal. The reinforcement component 6 is arranged so that the wireless charging receiver has high strength, is not easy to deform, and better matches the electronic product.

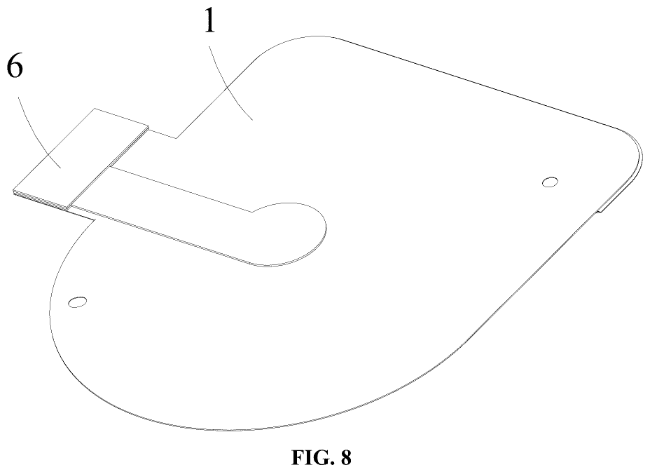

FIG. 7 is a diagram illustrating the temperature rise simulation of a wireless charging receiver during charging according to this embodiment. Compared with a conventional wireless charging receiver, the wireless charging receiver provided in the embodiments has the inner conductor wire 31 on the upper side of the first soft magnet 1, which reduces the vortex formed by the magnetic field of the receiving coil 2 on the inner conductor wire 31 so that the wireless charging receiver generates less heat, has a more uniform temperature, does not have a concentrated hot spot, and has a significant temperature improvement effect.

Further, as shown in the following Table 1, the temperature rise data of a wireless charging receiver provided in the related art before improvement and the temperature rise data of the wireless charging receiver provided in the embodiments after improvement are compared.

TABLE 1

| | | 100 KHz = | | | | | | Max: |
|---|---|---|---|---|---|---|---|---|
| | Inductance | resistance | Q- | | Current | B | Max: | temperature |
| State | (L) | (R) | Factor | Phase | (A) | (Tesla) | Efficiency_% | rise |
| Before | 8.2 uH | 281 mohm | 18.38 | 0 | 2 | 0.0395 | 81% | 58° |
| improvement | | | | | | | | |
| After | 8.2 uH | 281 mohm | 18.38 | 0 | 2 | 0.0056 | 83% | 51° |
| improvement | | | | | | | | |

The comparative experiment was conducted at a frequency of 100 KHz with the same inductance L, the same resistance R, and the same Q value. The inductance L is the capability of the receiving coil for storing magnetic field energy, and the value of the inductance L indicates the dimension of the coil or the number of windings of the coil; the value of the resistance R indicates the internal resistance of a coil wire; the Q value is a quality factor and indicates the performance of the coil at an operation frequency, and the Q value is specifically the ratio of the inductance L of the coil to the resistance R, that is, Q=ωL/R, where ω is the angular frequency (2× multiplied by the frequency). It can be clearly seen from the table that under the same conditions, relative to the solution in the related art, the improved solution in the embodiments effectively reduces the value of the magnetic induction intensity B (Tesla) in the inner conductor wire during wireless charging, lowers the temperature rise, improves the charging efficiency, and ensures the safety and service life of a device.

The embodiments further provide an electronic product. The electronic product includes a housing, a battery, and the wireless charging receiver in any of the preceding solutions. The battery and the wireless charging receiver are both mounted within the housing, and the wireless charging receiver is configured to charge the battery. When the electronic product provided in the embodiments approaches a charging base, the charging process includes that a transmitting coil within the charging base is supplied with an alternating current to generate a constantly changing magnetic field, the receiving coil 2 generates an induced current by sensing the changing magnetic field generated by the transmitting coil, and the induced current charges the battery after subsequent processing. In this embodiment, the vortex formed by the magnetic field of the receiving coil 2 on the inner conductor wire 31 is reduced, the heat generated by the wireless charging receiver is reduced, and the temperature rise of the electronic product is lowered. Moreover, the efficiency of wireless charging is improved, and the charging speed of the electronic product is accelerated.

Apparently, the preceding embodiments of the present application are only illustrative examples of the present application and are not intended to limit embodiments of the present application. Those of ordinary skill in the art can make various apparent modifications, adaptations, and substitutions without departing from the scope of the present application. All embodiments do not need to be and cannot be exhausted herein. Any modifications, equivalent substitutions, and improvements made within the spirit and principle of the present application fall within the scope of the claims of the present application.

What is claimed is:

1. A wireless charging receiver, comprising:
a first soft magnet provided with a first through hole passing through an upper surface of the first soft magnet and a lower surface of the first soft magnet;
a receiving coil arranged below the first soft magnet, wherein the receiving coil comprises a first connection end coiled on an inner side of the receiving coil and a second connection end coiled on an outer side of the receiving coil; and
a flexible circuit board comprising an inner conductor wire and an outer conductor wire, wherein the inner conductor wire is located above the first soft magnet and connected to the first connection end after passing through the first through hole, and the outer conductor wire is located below the first soft magnet and connected to the second connection end.

2. The wireless charging receiver of claim 1, wherein a portion of the outer conductor wire is arranged right below the first soft magnet, and another portion of the outer conductor wire is laterally exposed from the first soft magnet.

3. The wireless charging receiver of claim 2, wherein a portion of the inner conductor wire is arranged right above the first soft magnet, and another portion of the inner conductor wire is laterally exposed from the first soft magnet; and
an end portion of the inner conductor wire laterally exposed from the first soft magnet is connected to an end portion of the outer conductor wire laterally exposed from the first soft magnet.

4. The wireless charging receiver of claim 1, wherein a coverage area of the first soft magnet is larger than a coverage area of the receiving coil.

5. The wireless charging receiver of claim 1, wherein the inner conductor wire of the flexible circuit board comprises a plurality of sub-wires arranged in parallel.

6. The wireless charging receiver of claim 5, wherein the inner conductor wire of the flexible circuit board is a litz wire or a self-adhesive enameled wire.

7. The wireless charging receiver of claim 1, wherein the first connection end of the receiving coil is connected to the inner conductor wire of the flexible circuit board by welding, and the second connection end of the receiving coil is connected to the outer conductor wire of the flexible circuit board by welding.

8. The wireless charging receiver of claim 1, wherein the receiving coil is adhesively secured to the first soft magnet, and the first soft magnet is adhesively secured to the flexible circuit board.

9. The wireless charging receiver of claim 1, further comprising a rigid protective film component arranged on an outer side of the first soft magnet.

10. The wireless charging receiver of claim 1, further comprising a heat dissipation component, and the heat dissipation component is configured to dissipate heat of the receiving coil.

11. The wireless charging receiver of claim 1, further comprising a reinforcement component secured to the first soft magnet or the receiving coil.

12. An electronic product, comprising a battery and a wireless charging receiver, wherein the wireless charging receiver is configured to charge the battery; and
the wireless charging receiver comprises:
a first soft magnet provided with a first through hole passing through an upper surface of the first soft magnet and a lower surface of the first soft magnet;
a receiving coil arranged below the first soft magnet, wherein the receiving coil comprises a first connection end coiled on an inner side of the receiving coil and a second connection end coiled on an outer side of the receiving coil; and
a flexible circuit board comprising an inner conductor wire and an outer conductor wire, wherein the inner conductor wire is located above the first soft magnet and connected to the first connection end after passing through the first through hole, and the outer conductor wire is located below the first soft magnet and connected to the second connection end.

13. The electronic product of claim 12, wherein a portion of the outer conductor wire is arranged right below the first soft magnet, and another portion of the outer conductor wire is laterally exposed from the first soft magnet.

14. The electronic product of claim 13, wherein a portion of the inner conductor wire is arranged right above the first soft magnet, and another portion of the inner conductor wire is laterally exposed from the first soft magnet; and
an end portion of the inner conductor wire laterally exposed from the first soft magnet is connected to an end portion of the outer conductor wire laterally exposed from the first soft magnet.

15. The electronic product of claim 12, wherein a coverage area of the first soft magnet is larger than a coverage area of the receiving coil.

16. The electronic product of claim 12, wherein the inner conductor wire of the flexible circuit board comprises a plurality of sub-wires arranged in parallel.

17. The electronic product of claim 16, wherein the inner conductor wire of the flexible circuit board is a litz wire or a self-adhesive enameled wire.

18. The electronic product of claim 12, wherein the first connection end of the receiving coil is connected to the inner conductor wire of the flexible circuit board by welding, and the second connection end of the receiving coil is connected to the outer conductor wire of the flexible circuit board by welding.

19. The electronic product of claim 12, wherein the receiving coil is adhesively secured to the first soft magnet, and the first soft magnet is adhesively secured to the flexible circuit board.

20. The electronic product of claim 12, further comprising a rigid protective film component arranged on an outer side of the first soft magnet.
